(19) United States
(12) Patent Application Publication
(10) Pub. No.: US 2010/0017500 A1
(43) Pub. Date: Jan. 21, 2010

(54) Methods and systems for peer-to-peer proxy sharing

(75) Inventor: Rubik Lee, South Pasadena, CA (US)

Correspondence Address: Rubik Lee, 825 Columbia Street, South Pasadena, CA, 91030, US

(73) Assignee: Rubik Lee, South Pasadena, CA (US)

(21) Appl. No.: 12/175,437

(22) Filed: Jul. 17, 2008

(51) Int. Cl. G06F 15/16

(52) U.S. Cl. 709/219; 709/229

(57) ABSTRACT

The system and methods for providing peer-to-peer (p2p) proxy sharing in a distributed computer network. Each peer nodes can include a Hyper Text Transfer Protocol (HTTP) client and a p2p program. The p2p program provides the utilities for implementing the p2p network. A controller server connected to the network can manage system operations. A method of implementing p2p proxy sharing includes signing in and signing off functions to the p2p network, searching for p2p nodes, connecting to p2p nodes, managing connections between p2p nodes, processing HTTP request and HTTP response, forwarding and processing data between p2p nodes, managing connections from HTTP client, and managing connections to web servers.

### TECHNICAL FIELD

The system and methods relate to peer-to-peer proxy sharing, and more particularly over a distributed computer network such as the Internet.

### BACKGROUND

Current means of browsing the Internet includes utilizing the browser software on the local computer. By using the browser software on the local computer to browse web pages, the computer exposes its computer information to the web server or web site that the user is requesting from. The computer information exposed includes fields such as IP Address, operating system type, browser software, country, region, and more. With these information exposed, hackers can target the computer's vulnerabilities to gain access or control of the user computer, which poses a security threat. Furthermore, the web server can utilize the user's browsing history during a browsing session for traffic analysis, a form of network surveillance. This threatens personal freedom and privacy. To prevent this, the user can use an anonymous proxy server to access the Internet. However, to setup a proxy server is costly and requires a high level of computer expertise. Another method is to use a public proxy server that is currently available on the Internet. However, it is difficult to find free public proxy servers to utilize and there are not many out there. And, if one does find one, the connection of the proxy server is very slow because it is overloaded with users.

### SUMMARY

A system for providing peer-to-peer (p2p) proxy sharing can include peer nodes having a Hyper Text Transfer Protocol (HTTP) client and a p2p program. The p2p program provides the utilities for implementing the p2p network. A controller server connected to the network can manage system operations. A method of implementing p2p proxy sharing includes signing in and signing off functions to the p2p network, searching for p2p nodes, connecting to p2p nodes, managing connections between p2p nodes, processing HTTP request and HTTP response, forwarding and processing data between p2p nodes, managing connections from HTTP client, and managing connections to web servers.

In one embodiment, a system can provide peer-to-peer proxy sharing among a number of p2p nodes over the Internet. Each peer nodes can include a p2p program and a HTTP client. The p2p program can include a proxy server, a proxy client, and a main application having an interface with a peer node user. The proxy server and the proxy client can connect to other p2p nodes of the system to form a p2p proxy sharing session. The HTTP client communicates with the proxy client and interfaces with a peer node user. A controller server can be connected to the network and in communication with the peer nodes. The controller server can include a login server and a relay server. The login server can monitor activity of p2p connections and store p2p nodes Internet Protocol (IP) address information. The relay server can receive and forward data between p2p nodes.

In one embodiment, a method of proxy sharing in a p2p proxy sharing session can include accepting connection from HTTP client, managing connection from HTTP client, receiving HTTP request from HTTP client, processing HTTP request on proxy client, sending HTTP request to proxy server, awaiting request from proxy client, handling HTTP request on proxy server, awaiting HTTP response from web server, process HTTP response, managing connection to web server, awaiting data from proxy server, handling data from proxy server.

### DESCRIPTION OF THE DRAWINGS

The following figures depict certain illustrative embodiments in which like reference numerals refer to like elements. These depicted embodiments are to be understood as illustrative and not as limiting in any way.

FIG. 1 shows a schematic representation of a system for peer-to-peer proxy sharing;

FIG. 2 shows a schematic representation of a peer node of the system of FIG. 1;

FIG. 3 shows a schematic representation of a peer node's p2p program connecting with other peer node's p2p program of the system of FIG. 1;

FIG. 4 is a schematic flow diagram of installation, sign in, sign off procedures for the system of FIG. 1;

FIG. 5 is a schematic flow diagram of a method of creating a peer-to-peer proxy sharing session;

FIG. 6 is a schematic data flow diagram of an exemplary peer-to-peer data transfer session;

FIG. 7 is a schematic flow diagram of the proxy protocol for processing request; and

FIG. 8 is a schematic flow diagram of the proxy protocol for processing response.

### DETAILED DESCRIPTION OF THE PREFERRED EMBODIMENTS

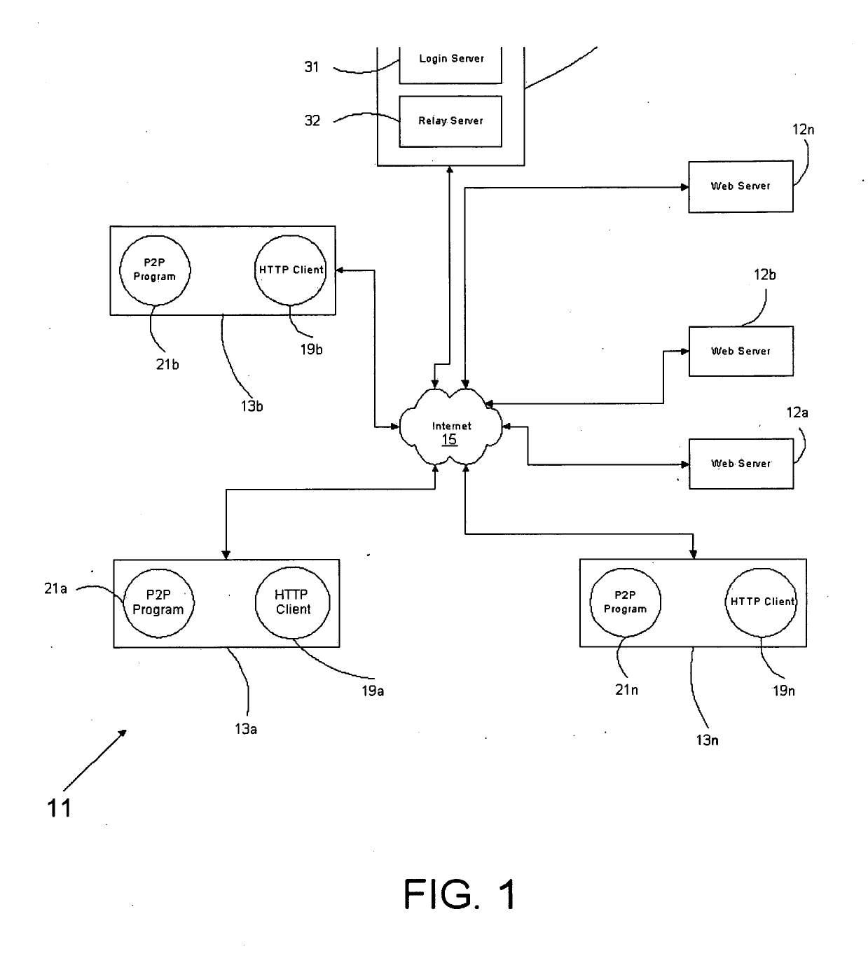

Referring to FIG. 1, a system 11 can provide peer-to-peer (p2p) proxy sharing among a number of p2p nodes 13a-13n over the Internet 15. A controller server 17 can manage system 11 operations. A controller server 17 includes a login server 31 and a relay server 32. A login server 31 manages p2p activities, and store Internet Protocol (IP) address and presence information for each p2p node 13a-13n. A p2p node connected to the p2p network of system 11 is considered to be online. A p2p node disconnected from the p2p network of system 11 is considered to be offline. The login server 31 can process search requests and return results to p2p nodes. The relay server 32 can receive and forward data between p2p nodes 13a-13n. Each node 13a-13n can include a Hyper Text Transfer Protocol (HTTP) client program 19a-19n and a p2p program 21a-21n. The p2p program 21a-21n can communicate with Internet 15 to the web servers 12a-12n, and to the HTTP client program 19a-19n. The p2p program 21a-21n can handle communications between peer nodes.

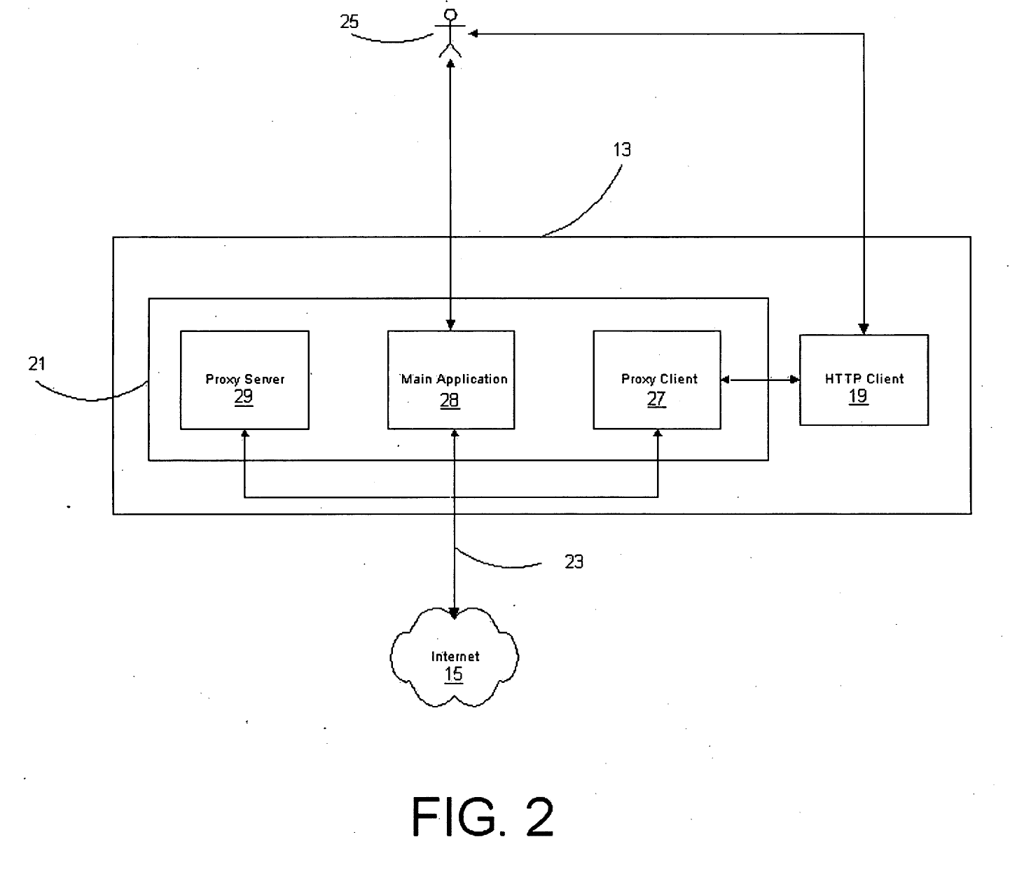

FIG. 2 illustrates a peer node 13 of system 11. The p2p program 21 can connect to the Internet 15 through connection 23, as is know in the art. The p2p program 21 can include a proxy server 29, a main application 28, and a proxy client 27. The HTTP client 19 can be a web browser or a program that can send HTTP request and receive HTTP response. The HTTP client 19 can interface with a user 25. HTTP client 19 communicates with p2p program 21 via proxy client 27 of p2p program 21. The main application 28 of p2p program 21 can provide the interface to a user 25. Furthermore, main application 28 can provide the administrative functions of a p2p program 21, including sign in, sign off, add, delete, exit, and other functions as will be described in further details below.

The main application 28 in turn communicates with proxy server 29 and proxy client 27. Proxy server 29 and proxy client 27 can provide the basic tools required for proxy sharing in the p2p environment. Proxy Server 29 can include tools for managing connections and processing requests from p2p nodes through Internet 15. Managing connections can include features to accept connection, disconnect connection, and place connection in queue. Processing requests can include features to receive request from other proxy clients on p2p nodes, forward the request to web server 12 through Internet 15, receive response from web server 12, and send response back to proxy clients on p2p nodes. Proxy client 27 can provide the tools for managing connections from HTTP client 19 and processing request from HTTP client 19. Managing connections can include features to connect, disconnect, and delete a connection. Processing requests can include features to forward requests to other proxy servers on p2p nodes through Internet 15, and receive responses back from proxy servers on p2p nodes through Internet 15.

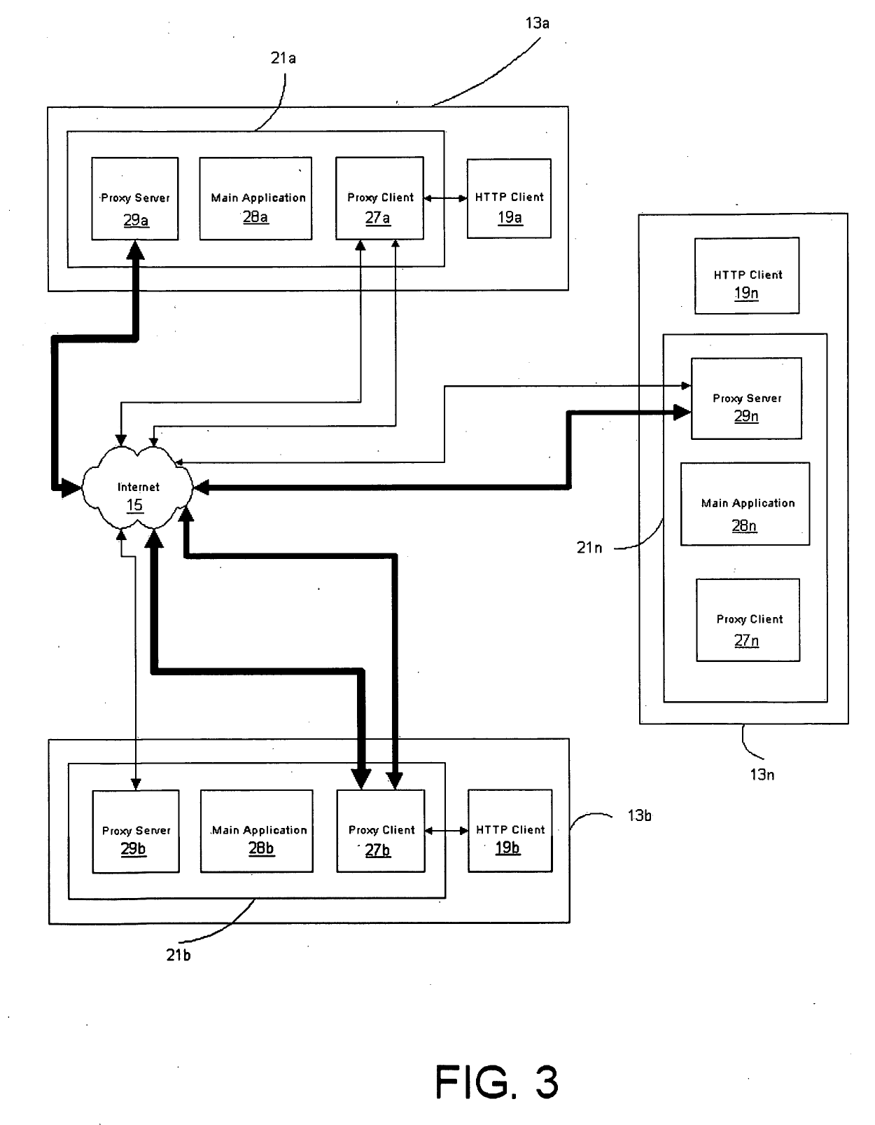

FIG. 3 shows a schematic representation of a peer node's proxy client connecting with other peer node's proxy server, and the peer node's proxy server is connected by other peer node's proxy client of system 11 to create p2p proxy sharing. For example, proxy client 27a can connect to a plurality of proxy servers 29b-29n on p2p nodes 13b-13n through Internet 15 and proxy server 29a can process request from a plurality of proxy client 27b-27n on p2p nodes 13b-13n through Internet 15. Proxy client 27b can connect to a plurality of proxy servers 29a-29n on p2p nodes 13a-13n through Internet 15 and proxy server 29b can process request from a plurality of proxy client 27a-27n on p2p nodes 13a-13n through Internet 15 in system 11.

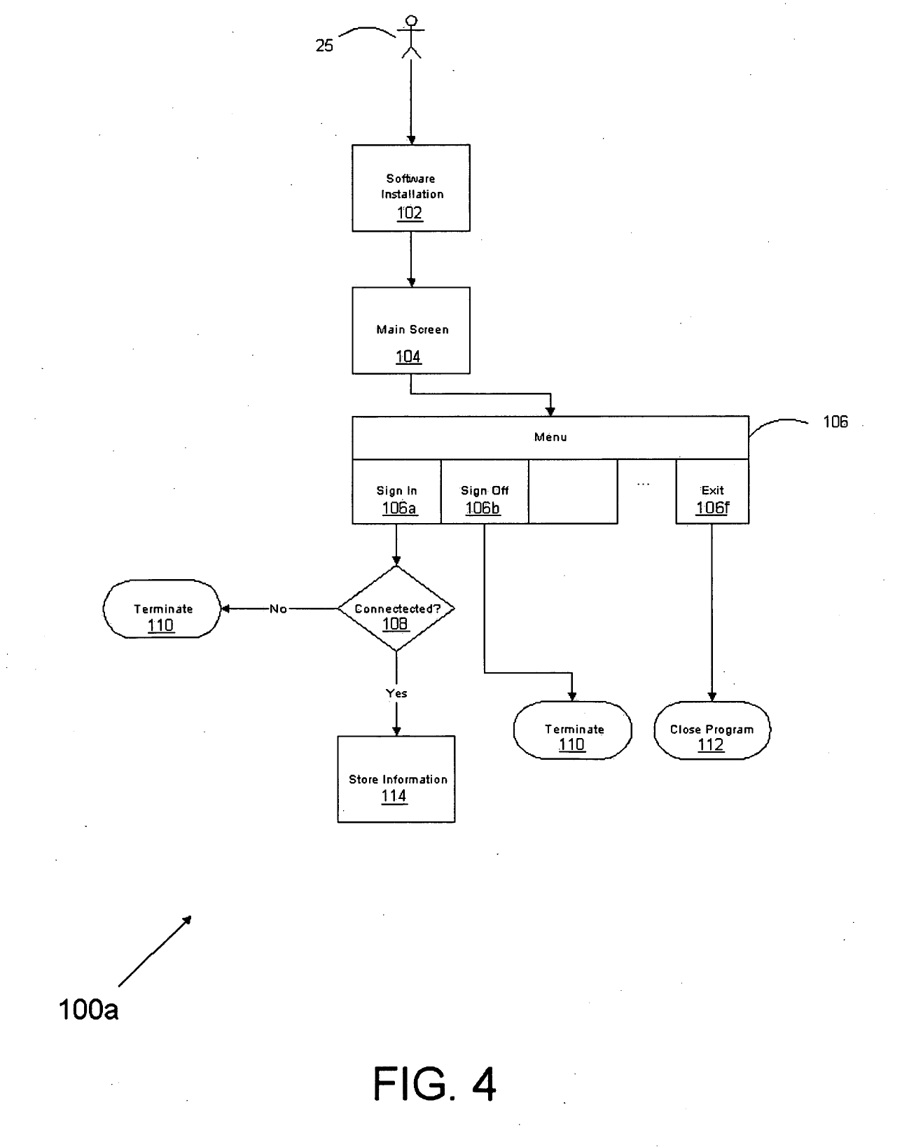

Referring now to FIGS. 4-6, there are shown schematic flow diagrams for a method 100 implementing the functionally of system 11. FIG. 4 shows a flow diagram for a portion of 100a of method 100, which provides user installation, sign in and sign off functions for system 11. First, the user 25 installs the p2p program as at 102. Once installation is complete, the p2p program starts and the user can be directed to the main screen 104 for interfacing with system 11. From the main screen, a menu 106 can be presented to the user, which can include various actions the user may choose. If the user chooses to sign in 106a, the p2p program connects to the login server 31 as at 108. If connection is established, the login server 31 stores the IP address and presence information as at 114. This peer node is now online and connected to the p2p network. If connection fails, the user is disconnected from system 11 as at 110. If the user chooses to sign off 106b, connection to system 11 is terminated as at 110 and this peer node is now offline. If the user chooses to exit 106f, the p2p program closes as at 112.

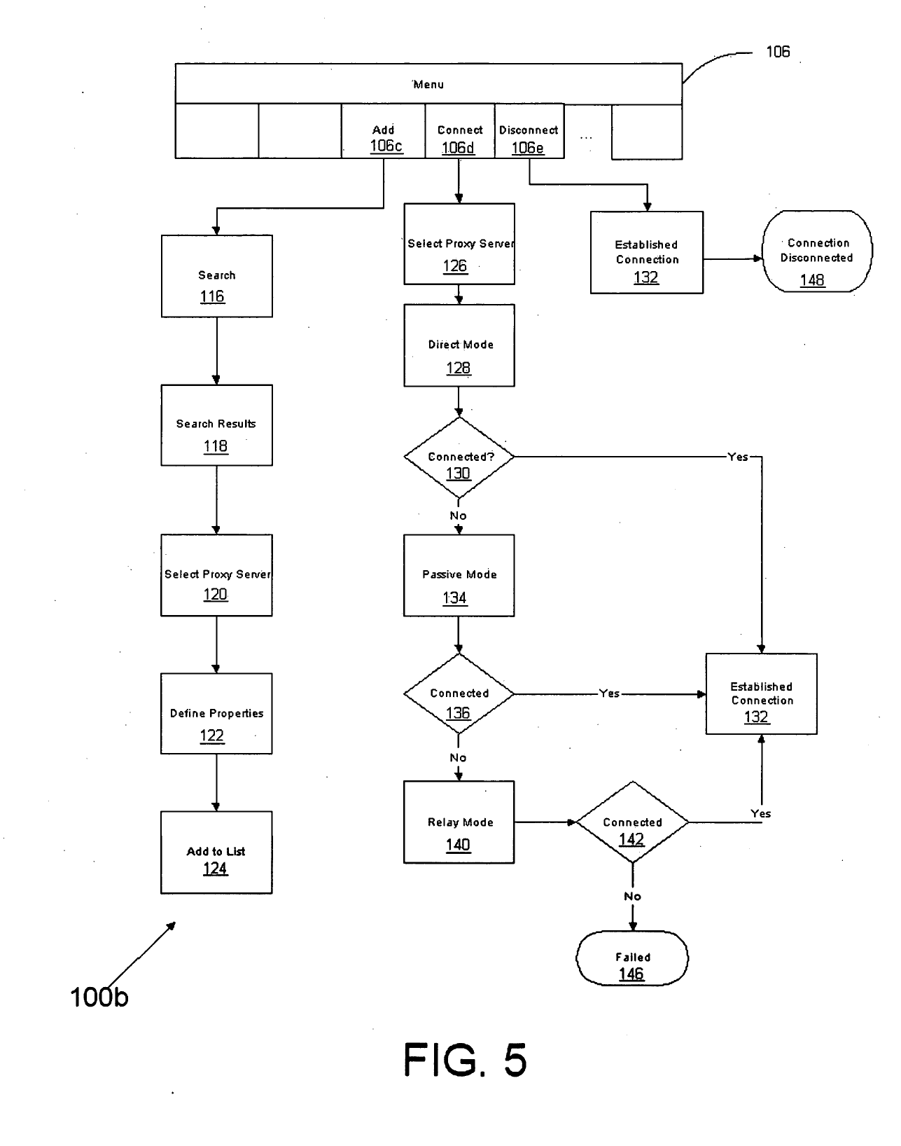

FIG. 5 shows a flow diagram for a portion of 100b of method 100 when the user chooses to add a proxy server 29 on a p2p node to create a p2p proxy sharing session. After the user has sign in and connected to system 11, the user can add a proxy server 29 from the menu 106c by doing a search, as at 116. The search interface can include search parameters. The user can specify the search by the location of the p2p node such as country or state, for new p2p node, and/or p2p nodes that has not been used for a specific duration. After making the selections, the user submits the search to the login server 31. The login server 31 process the search and returns with a list of search results of online proxy servers 29 on p2p nodes connected to system 11 as at 118 to the user. The user selects the proxy server 29 from the search results list as at 120. The user can define properties for the proxy server 29 as at 122. Property fields that can be defined are port number, send cookies, never send cookies, and user-agent. Next, the proxy server 29 is added to the list as at 124.

After adding the proxy server 29, the user can connect to a proxy server 29 as at 106d. The user selects a proxy server 29 from the list as at 126 and tries to connect. The user can be connected to a proxy server 29 using three different connection methods. First, the direct mode connection method is tried as at 128. The direct mode method is a method of connecting two p2p nodes directly through Internet 15. Direct mode can fail if the p2p node being connected does not have an open incoming port available for connection. The open port can be blocked by a firewall, either a hardware device or software program. As at 130, if the direct mode can connect, a connection is established as at 132. If the direct mode method fails, passive mode connection method is tried as at 134. Passive mode connection is used when the p2p node being connected does not have an open incoming port. The p2p node being connected sends outgoing connections request to the proxy client to establish connection between the two p2p nodes. As at 136, if the passive mode can connect, a connection is established as at 132. If passive mode method fails, relay mode method is tried as at 140. Relay mode method uses the relay server 32 to forward all data between two p2p nodes. As at 136, if the relay mode can connect, a connection is established as at 132. If the relay method fails, the p2p node has failed to establish a connection. After connecting to a proxy server 29 on a p2p node, the user can disconnect the connection. From the menu as at 106e, the user selects disconnect and the connection is terminated as at 148.

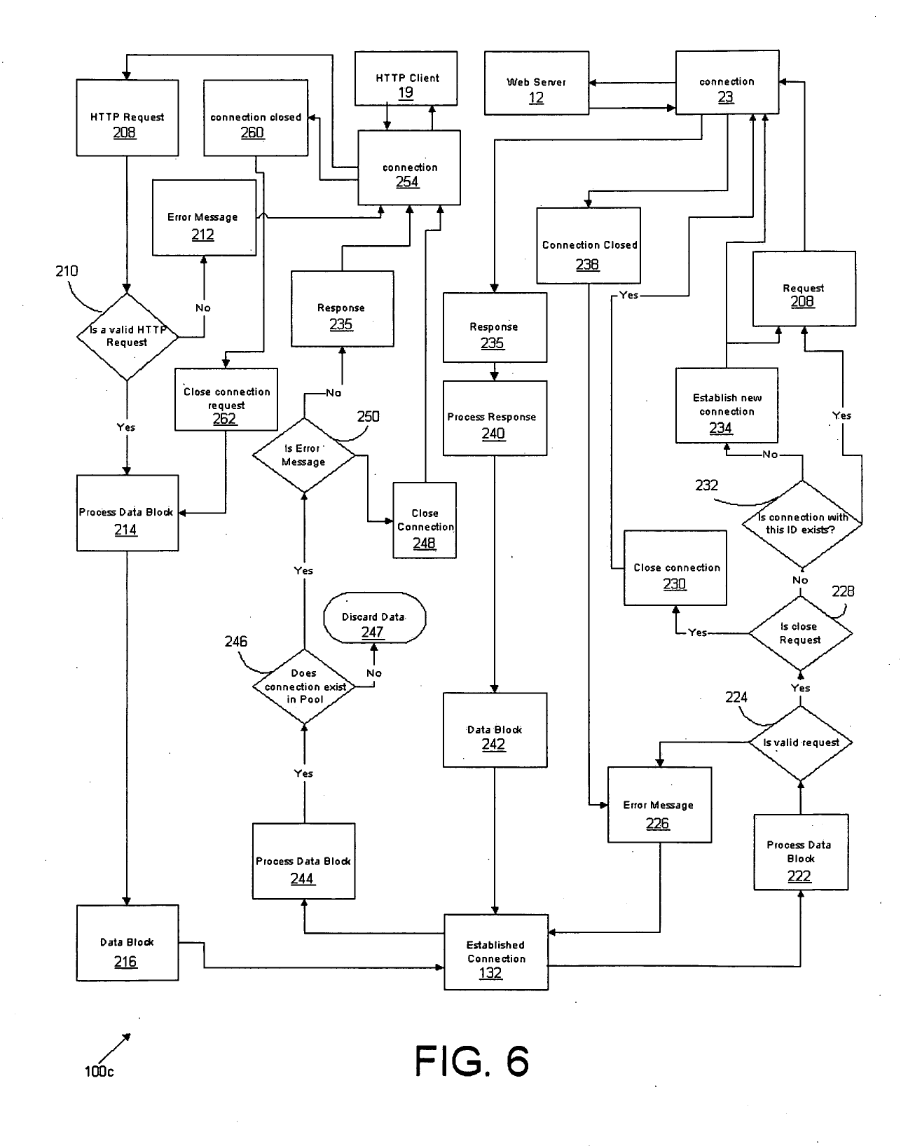

Referring to FIG. 6, it shows a schematic data flow diagram for a portion of 100c of method 100 of an exemplary peer-to-peer proxy sharing between p2p nodes: For the exemplary session of FIG. 6, a user can initiate a connection 254 from p2p node by using HTTP client 19. HTTP client 19 can send HTTP request 208 to proxy client 27. After receiving the complete HTTP request, proxy client 27 can check the HTTP request for errors. If HTTP request 208 is an invalid request, an error message 212 can be sent to HTTP client 19. The connection 254 can be closed. If HTTP request 208 is a valid request, request can be processed, as at 214. After request is processed, the data block 216 is sent to another p2p node through the established connection 132. When the proxy server 29 on another p2p node receives the data block 216 from connection 132, the proxy server 29 starts to process the data block, as at 222. After the request data is processed, the proxy server 29 can check if the request is a valid request, as at 224. If the request is not a valid request, the proxy server 29 can send an error message 226 back to proxy client 27 through the established connection 132. As at 224, if the request is valid, proxy server 29 can check if the request is a close connection request 262, as at 228. If the request is a close connection request 262, the proxy server 29 can close the corresponding connection 23, as at 230. If the request is an HTTP request, proxy server 29 can check if the connection for this id of this request exists, as at 232. If the connection does not exist, proxy server 29 can establish a new connection to web server 12, as at 234. Then, proxy server 29 can sent the HTTP request 208 to web server 12 through connection 23.

When the proxy server 29 receives response 235 from web server 12, the proxy server 29 can process the response 235, as at 240 and send the processed data block 242 back to proxy client 27 through the established connection 132. After proxy client 27 receives the data block, proxy client 27 processes the data block, as at 244. Proxy client 27 can check if the connection corresponding to the response exists, as at 246. If the connection does not exist, proxy client 27 can discard the response data, as at 247. Proxy client 27 can check the response, as at 250. If the response is the error message 226, proxy client 27 can close the corresponding connection, as at 248. If the response is the HTTP response 235, proxy client 27 can send the response 235 to HTTP client through corresponding connection 254.

A user can interrupt HTTP requests by closing the HTTP client 19. The connection 254 can be closed by HTTP client 19, as at 260. After the connection 254 is closed, proxy client 27 can generate a close connection request 262 and send this message to a proxy server 29 on another p2p node. After proxy server 29 receives the message, proxy server 29 can close the corresponding connection to web server, as at 230.

The connection 23 can be close by web server 12 or by a disconnected Internet connection. After the connection 23 is closed, proxy server 29 can generate an error message 226 and sent to proxy client 27 on another p2p node. After receives the message 226, the proxy client 27 can close the corresponding connection to HTTP client 19, as at 248.

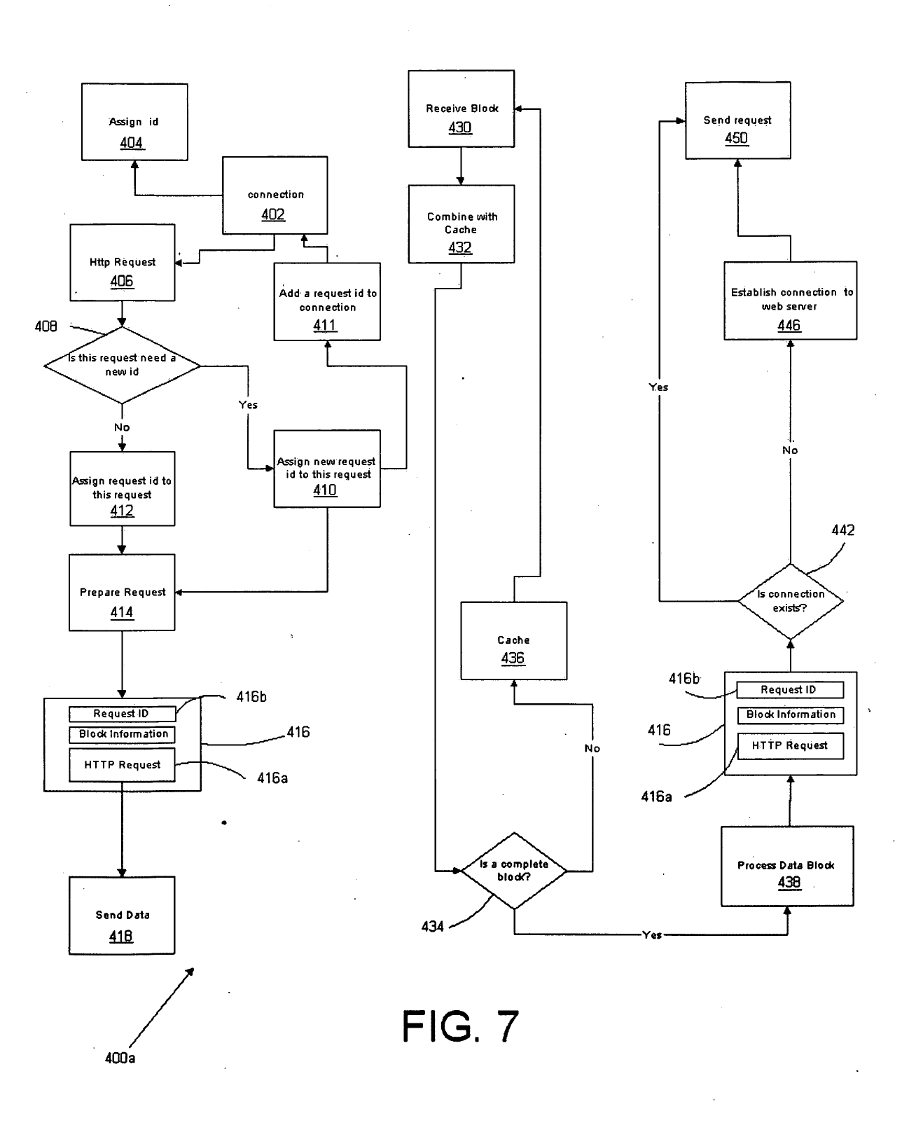

In order to efficient data transfer among peers, the method 100 can include a proxy protocol 400. Proxy protocol 400 can process HTTP request and HTTP response from multiple connection and transfer data between p2p nodes through a single established connection 132. FIG. 7 shows portion 400a of proxy protocol 400. After a connection 402 is established, proxy client can assign a request id to the connection 402. The connection 402 can have one or multiple request id. Since HTTP clients can use different HTTP protocol to communicate with proxy client, a HTTP client can establish connection to the proxy client for each HTTP request or establish one connection to send multiple HTTP requests to proxy client. When proxy client receives HTTP request 406 from connection 402, proxy client can parse the HTTP request 406 and check if a new requested id needs to be assigned to the request. If the HTTP request is requesting a different domain than the previous HTTP request, a new request id can be generated and assigned to the request, as at 410. Proxy client can add the new generated request id to connection 402, as at 411. The new generated request id can be used for the next HTTP request received from connection 402. If proxy client does not need to assign a new request id to this request, the previous request id can be assigned to this request, as at 412. The HTTP request can be processed by proxy client, as at 414. A data block 416 can be created. After the data block is created, proxy client can sent the data block to a proxy server on another p2p node using established connection 132.

When a proxy server receives data block, as at 430, proxy server can combine the data block with cache, as at 432. Proxy server checks if a complete data block is received, as at 434. If a data block is not completely received, proxy server can put the data in cache, as at 436, and continue to receive data, as at 430. After proxy server receives a complete data block, proxy server processes the data block, as at 438. The data block is converted to data block 416 which can include request id 416b, block information, and an HTTP request 416a. Next, the proxy server can check if a connection with this request id 416b exists, as at 442. If the connection exists, proxy server sent HTTP request 416a to the connection, as at 450. If the connection does not exist, proxy server can establish a new connection to corresponding web server, as at 446 and assign it with the request id 416b. Then, proxy server can send the HTTP request, as at 450.

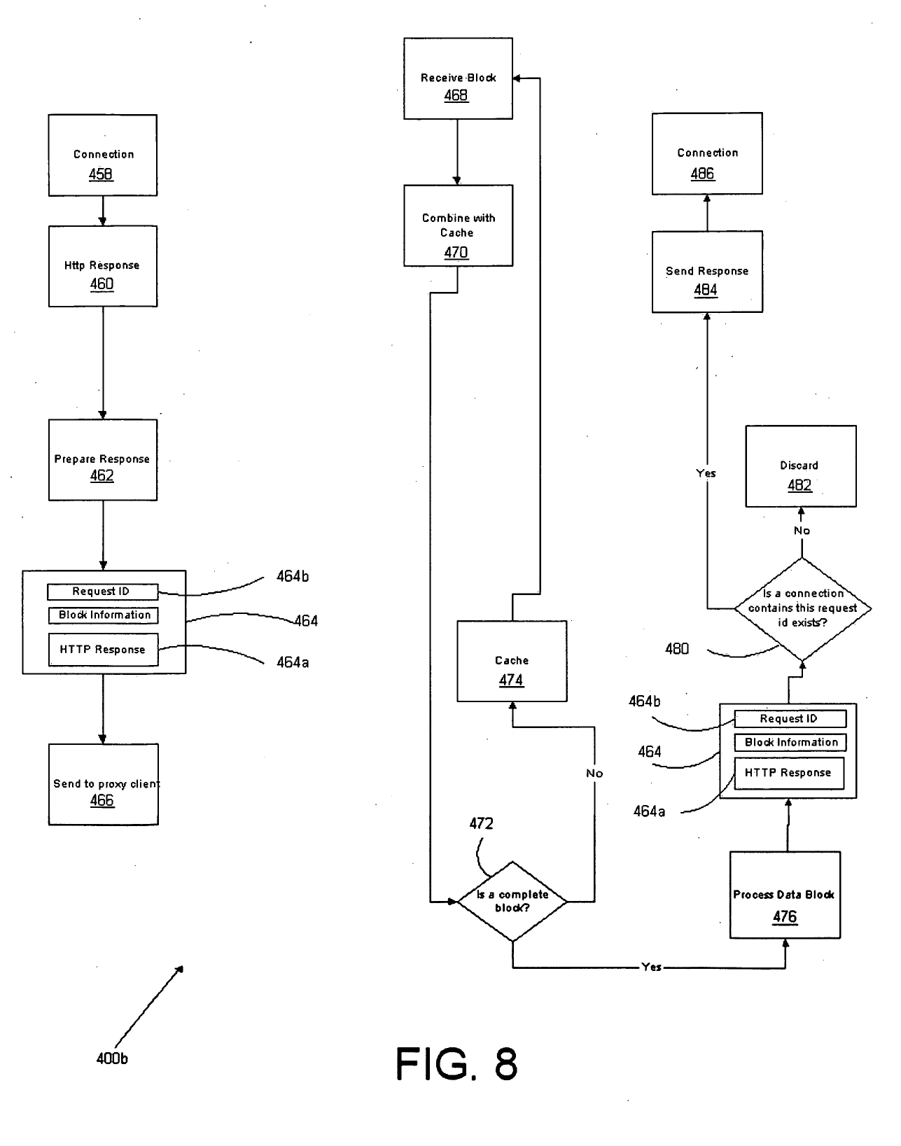

Referring now to FIG. 8, show portion 400b of proxy protocol 400. When proxy server receives HTTP response from connection 458, as at 460, proxy server can process the HTTP response, as at 462. Proxy server can assigns connection 458's request id to this HTTP response, as at 464. Then, proxy server can send the data block 464 to proxy client, as at 466.

When a proxy client receives data block, as at 468, proxy client can combine the data block with cache, as at 470. Proxy client checks if a complete data block is received, as at 472. If a data block is not completely received, proxy server can put the data in cache, as at 474, and continue to receive data, as at 470. After proxy client receive a complete data block, proxy client processes the data block, as at 476. The data block is converted to data block 464 which can include request id 464b, block information, and an HTTP response 464a. Next, the proxy client can check if a connection containing this request id 464b exists, as at 480. If the connection exists, proxy client sent HTTP response 464a to the connection 486, as at 484. If the connection does not exist, the response data 464a can be disposed, as at 482.

While the systems and implementations thereof have been disclosed in connection with certain embodiments shown and described in detail, various modifications and improvements thereon will become readily apparent to those skilled in the art. Those with ordinary skill in the art will recognize that the arrangement and connectivity of the components and activities shown in the figures are merely for illustrative purposes, and can be varied accordingly and components and activities may be combined or otherwise reconfigured without departing from the scope of the disclosed systems and methods. For example, it can be understood that component and data flow configurations of p2p program, HTTP client, and web server, other than that illustrated in FIG. 5, can be contemplated so as to provide the functionality described herein.

The systems and methods described herein may not be limited to a particular hardware or software configuration; they may find applicability in many communication environments. The techniques may be implemented in hardware or software, or a combination thereof The systems and methods can be implemented in one or more computer programs executing on one or more programmable computers, such as may be exemplified by the web server 12a-12n and peer nodes 21a-21n of FIG. 1, among others, that include a processor, a storage medium readable by the processor, one or more input devices, and one or more output devices.

The computer programs, or programs, may be preferably implemented using one or more high level procedural or object-oriented programming languages to communicate with a computer system; however, the program(s) can be implemented in assembly or machine language, if desired. The language can be compiled or interpreted. The computer program(s) can be preferably stored on a storage medium or device (e.g., CD-ROM, hard disk or magnetic disk) readable by a general or special purpose programmable computer for configuring and operating the computer when the storage medium or device is read by the computer to perform the procedures described herein. The system can also be considered to be implemented as a computer-read-able storage medium, configured with a computer program, where the storage medium so configured causes a computer to operate in a specific and predefined manner.

While the method and systems have been disclosed in connection with the preferred embodiments shown and described in detail, various modifications and improvements thereon will become readily apparent to those skilled in the art. As an example, those with ordinary skill in the art will recognize that the arrangement and connectivity of the components shown in the figures are merely for illustrative purposes, and can be varied accordingly and components may be combined or otherwise reconfigured without departing from the scope of the disclosed systems and methods. Accordingly, many additional changes in the details and arrangement of parts, herein described and illustrated, can be made by those skilled in the art. It will thus be understood that the following claims are not to be limited to the embodiments disclosed herein, can include practices otherwise than specifically described, and are to be interpreted as broadly as allowed under the law.

What is claimed is:

1. A system for peer-to-peer (p2p) proxy server sharing between a plurality of peer nodes connected to a network, comprising:
a main application for each node in communication with the network and having an interface with a user of the peer node;
a proxy client for each peer node in communication with the main application and having proxy client tools therein;
a proxy server for each peer node in communication with the main application; and
a controller server that includes a login server that can store p2p node's Internet Protocol (I-P) address and presence information, and process search requests; and a relay server to transfer data between p2p nodes.

2. The system of claim 1, comprising a HTTP client for each peer node in communication with the proxy client and the user.

3. The system of claim 1, comprising a peer node network in communication between the controller server and at least one of the peer nodes.

4. The system of claim 3, wherein the peer node network is the Internet.

5. A method of proxy sharing in a peer-to-peer network, comprising:
Searching for proxy servers on the p2p network;
Connecting to proxy server on a p2p node;
Disconnecting connection between p2p nodes;
Accepting connection from HTTP client;
Managing connection from HTTP client;
Receiving HTTP request from HTTP client;
Processing HTTP request on proxy client;
Sending HTTP request to proxy server;
Awaiting data from proxy server,
Handling data from proxy server;
Awaiting request from proxy client;
Handling HTTP request on proxy server;
Awaiting HTTP response from web server;
Process HTTP response,
Managing connection to web server;

6. The method of claim 5, wherein connecting to a proxy server on a p2p node comprises:
Connect to a p2p node using the direct mode;
Connect to a p2p node using the passive mode;
Connect to a p2p node using the relay mode;

7. The method of claim 5, wherein disconnecting connection between p2p nodes comprises:
Disconnecting connection to proxy server;
Disconnecting connection from proxy client;

8. The method of claim 5, wherein managing connection from HTTP client comprises:
Assigning request id to connection;
Putting a connection in connection pool;
Finding a connection by a request id;
Sending notification to corresponding p2p node when connection is disconnected;
Close a connection when proxy server sends a closing request;

9. The method of claim 5, wherein Processing HTTP request on proxy client comprises:
Determining if a valid HTTP request has been received;
Send error message back to HTTP client and close the connection when an invalid HTTP request is received;
Package the HTTP request, attach request id, and block information when it is a valid HTTP request;

10. The method of claim 5, wherein awaiting request from proxy client comprises:
Iteratively receive data block from proxy client;
Determining if a complete data block is received;
Pass data block to next process wherein handling HTTP request on proxy server when a complete data block is received;

11. The method of claim 5, wherein handling HTTP request on proxy server comprises:
Retrieving request id from data block;
Retrieving HTTP request from data block;
Parsing HTTP request;
Establishing a new connection and assigning request id to it when connection does not exist;
Forward the HTTP request to web server;

12. The method of claim 5, wherein managing connection to web server comprises:
Managing connection in connection pool;
Find a connection by request id;
Sending notification to proxy client when the connection status of a connection is disconnected;
Close a connection when proxy client sends close request;

13. The method of claim 5, wherein Process HTTP response comprises:
Packaging the HTTP response;
Attach request id and block information;
Sending response back to proxy client;

14. The method of claim 5, wherein Awaiting data from proxy server comprises:
Iteratively receive data block from proxy server;
Determining if a complete data block is received;
Pass data block to next process wherein handling data from proxy server when a complete data block is received;

15. The method of claim 5, wherein handling data from proxy server comprises:
Retrieving request id from data block;
Retrieving message from data block;
Finding a connection by request id;
Closing connection when message is an error message;
Sending message to HTTP client through connection when message is a HTTP response;
Discarding the message when a connection is not found;
